(19) United States
(12) Patent Application Publication
(10) Pub. No.: US 2025/0189838 A1
(43) Pub. Date: Jun. 12, 2025

(54) DISPLAY PANEL AND TILED DISPLAY USING THE SAME

(71) Applicant: AUO Corporation, Hsinchu City (TW)

(72) Inventors: Shang-Wei HSIEH, Hsinchu City (TW); Jia-Hong Wang, Hsinchu City (TW); Yi-Wen Lin, Hsinchu City (TW); Wang-Shuo Kao, Hsinchu City (TW); Ya-Ling Hsu, Hsinchu City (TW); Chen-Hsien Liao, Hsinchu City (TW)

(21) Appl. No.: 18/947,008

(22) Filed: Nov. 14, 2024

(30) Foreign Application Priority Data
Dec. 11, 2023 (TW) 112148176

(51) Int. Cl. G02F 1/1333

(52) U.S. Cl. CPC G02F 1/13336; G02F 1/133308; G02F 1/133357; G02F 1/133388

(57) ABSTRACT

A display panel includes a first substrate, a second substrate, a sealant configured to mount the first substrate and the second substrate at a frame area; a display array disposed at a display area of the first substrate and the second substrate, in which the display area is surrounded by the frame area, a planarization layer disposed on an outer surface of the first substrate and including a plurality of reflective cavities, and a micro-LED array disposed at the frame area and including a plurality of micro-LEDs. The micro-LEDs are disposed in the reflective cavities.

### CROSS-REFERENCE TO RELATED APPLICATION

This application claims priority to Taiwan Application Serial Number 112148176, filed Dec. 11, 2023, which is herein incorporated by reference in its entirety.

### BACKGROUND

### Field of Invention

The present disclosure relates to a display panel and a tiled display using the same.

### Description of Related Art

With the technique improvement and media rapid development, more and more flat panel displays such as liquid crystal displays (LCDs) have been developed and become main trend of display. The demand of large size display grows fast. A large-size commercial display can be constructed by merging plural LCDs. If the frames of the LCDs utilized being merged in the large-size commercial display are too thick, the display image may be broken, and the display performance is not satisfied.

### SUMMARY

An aspect of the disclosure provides a display panel. The display panel includes a first substrate, a second substrate, a sealant configured to mount the first substrate and the second substrate at a frame area, a display array disposed at a display area of the first substrate and the second substrate, in which the display area is surrounded by the frame area, a planarization layer disposed on an outer surface of the first substrate and including a plurality of reflective cavities, and a micro-LED array disposed at the frame area and including a plurality of micro-LEDs. The micro-LEDs are disposed in the reflective cavities.

According to some embodiments of the disclosure, a surface of each of the reflective cavities is disposed with a reflective layer.

According to some embodiments of the disclosure, the first substrate is a color filter substrate, and the planarization layer is disposed on the outer surface of the color filter substrate.

According to some embodiments of the disclosure, each of the reflective cavities is a trapezoid structure, each of the reflective cavities is filled with a filling material, and an angle between a sidewall of each of the reflective cavities and the outer surface of the color filter substrate is in a range from 50 degrees to 60degrees.

According to some embodiments of the disclosure, the filling material is recessed form a top surface of the planarization layer.

According to some embodiments of the disclosure, a top surface of the filling material is above a top surface of the planarization layer, and a distance between the top surface of the filling material and the top surface of the planarization layer is equal to or less than ⅓ of a thickness of the planarization layer.

According to some embodiments of the disclosure, the display panel further includes an isolation layer disposed between the color filter substrate and the planarization layer.

According to some embodiments of the disclosure, a surface of each of the reflective cavities is disposed with a reflective layer that laterally extended from each of the reflective cavities to a top surface of the planarization layer by a distance, and the distance is equal to or less than 5 μm.

According to some embodiments of the disclosure, the first substrate is an array substrate, and the planarization layer is disposed on the outer surface of the array substrate.

According to some embodiments of the disclosure, each of the reflective cavities is a trapezoid structure, each of the reflective cavities is filled with an insulating protrusion, and an angle between a sidewall of each of the reflective cavities and the outer surface of the array substrate is in a range from 25 degrees to 45 degrees or 60 degrees to 80 degrees.

According to some embodiments of the disclosure, each of the reflective cavities is a trapezoid structure, each of the reflective cavities is filled with an air media, and an angle between a sidewall of each of the reflective cavities and the outer surface of the array substrate is in a range from 25 degrees to 45 degrees.

According to some embodiments of the disclosure, each of the reflective cavities is a dome structure, each of the reflective cavities is filled with an insulating protrusion, and a ratio of a depth to a width of each of the reflective cavities is in a range from 0.2 to 0.3.

According to some embodiments of the disclosure, the sealant includes a plurality of scatter particles.

According to some embodiments of the disclosure, the planarization layer continuously extends from the frame area to the display area.

According to some embodiments of the disclosure, the micro-LEDs are disposed in the reflective cavities, respectively.

Another aspect of the disclosure provides a tiled display. The tiled display includes a plurality of display panel. Each of the display panel includes a first substrate, a second substrate, a sealant configured to mount the first substrate and the second substrate at a frame area, a display array disposed at a display area of the first substrate and the second substrate, in which the display area is surrounded by the frame area, a planarization layer disposed on an outer surface of the first substrate and including a plurality of reflective cavities, and a micro-LED array disposed at the frame area and including a plurality of micro-LEDs. The micro-LEDs are disposed in the reflective cavities. The display panels are tiled such that the micro-LED arrays of the display panels are between the display arrays of the display panels.

According to some embodiments of the disclosure, a surface of each of the reflective cavities is disposed with a reflective layer.

According to some embodiments of the disclosure, the micro-LEDs are disposed in the reflective cavities, respectively.

According to some embodiments of the disclosure, the first substrate is a color filter substrate, and the planarization layer is disposed on the outer surface of the color filter substrate.

According to some embodiments of the disclosure, the first substrate is an array substrate, and the planarization layer is disposed on the outer surface of the array substrate.

The display panel allows the light field shape of LED at the frame area similar to the light field shape of LCD at the display area, to solve the problem of view angle discontinuous caused by the different light field shapes between LCD and LED.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic top view of a display panel according to some embodiments of the disclosure.

FIG. 2A to FIG. 2E are cross-sectional views of different manufacturing stages of the display panel according to some embodiments of the disclosure.

FIG. 3A is a front view angle diagram of a μLED.

FIG. 3B to FIG. 3E are simulation front view angle diagrams of a μLED disposed in the reflective cavity as shown in the display panel of FIG. 2D with different angles θ.

FIG. 4A to FIG. 4D are cross-sectional views of different manufacturing stages of the display panel according to some embodiments of the disclosure.

FIG. 5A to FIG. 5F are simulation light fields of a μLED disposed in the reflective cavity as shown in the display panel of FIG. 4D with different angles θ.

FIG. 6 is a cross-sectional view of the display panel according to some other embodiments of the disclosure.

FIG. 7A to FIG. 7E are simulation light fields of a μLED disposed in the reflective cavity as shown in the display panel of FIG. 6 with different D/W (depth to width) ratios.

FIG. 8A to FIG. 8D are cross-sectional views of different manufacturing stages of the display panel according to some embodiments of the disclosure.

FIG. 9A to FIG. 9F are simulation light fields of a μLED disposed in the reflective cavity as shown in the display panel of FIG. 8D with different angles θ.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

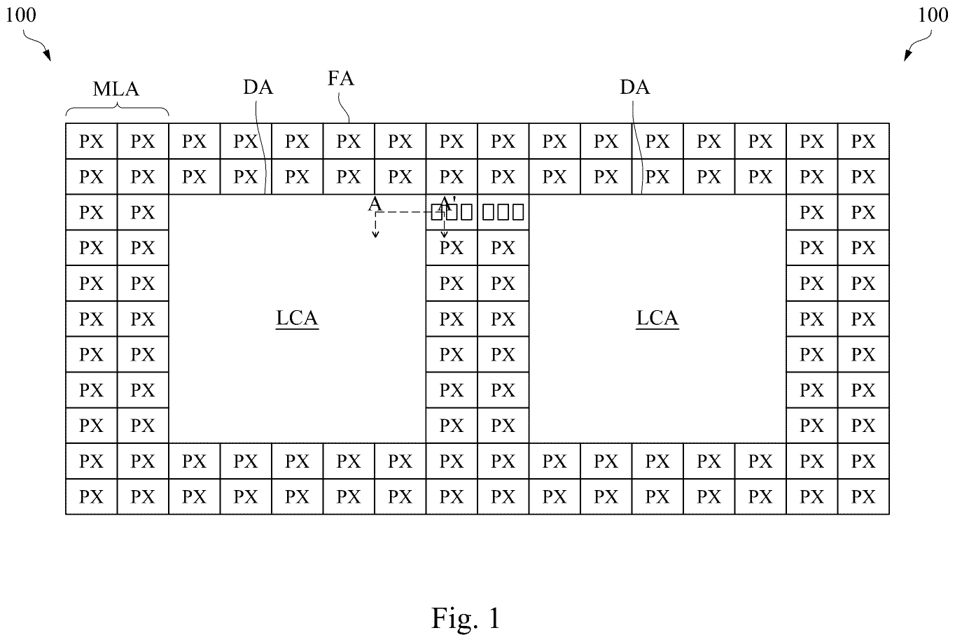

Reference is made to FIG. 1, which is a schematic top view of a display panel according to some embodiments of the disclosure. In some embodiments, the display panels 100 are utilized in a tiled display. Namely, plural displays 100 can be tiled horizontally and/or vertically to construct a large-size display device. The display panels 100 can be LCDs, but the disclosure is not limited to. In some other embodiments, the display technique of the disclosure can utilized in OLED display, quantum dot display, or LED display, etc.

Each of the displays 100 has a display area DA and a frame area FA that surrounds the display area DA. In order to provide frameless display effect, each of the display panels 100 of the present disclosure includes a micro display array at the frame area FA. If the display panel 100 is an LCD, a liquid crystal display array LCA is formed in the display area DA, and the micro display array at the frame area FA can be micro-LED (μLED) array MLA.

More particularly, the μLED array MLA includes a plurality of pixels PX, and each of the pixels PX includes a plurality of sub-pixels which may include blue micro-LED, red micro-LED, green micro-LED, white micro-LED, or combinations thereof. It is noted that the arrangement of the pixels PX in the μLED array MLA and the number and colors of the sub-pixels of each pixel PX can be varied according to different design requirements.

However, the light is emitted by individual μLED in the μLED array MLA, and the light of the liquid crystal display array LCA is provided by a backlight module underneath thus the light is vertically emitted from the liquid crystal display array LCA. The light field of the μLED array MLA is more dispersed, and the light field of the liquid crystal display array LCA is more collimated. Therefore, the display panel 100 of the present disclosure is related to an structural improvement of the μLED array MLA, such that the light field of the μLED array MLA is more similar to the light field of the liquid crystal display array LCA.

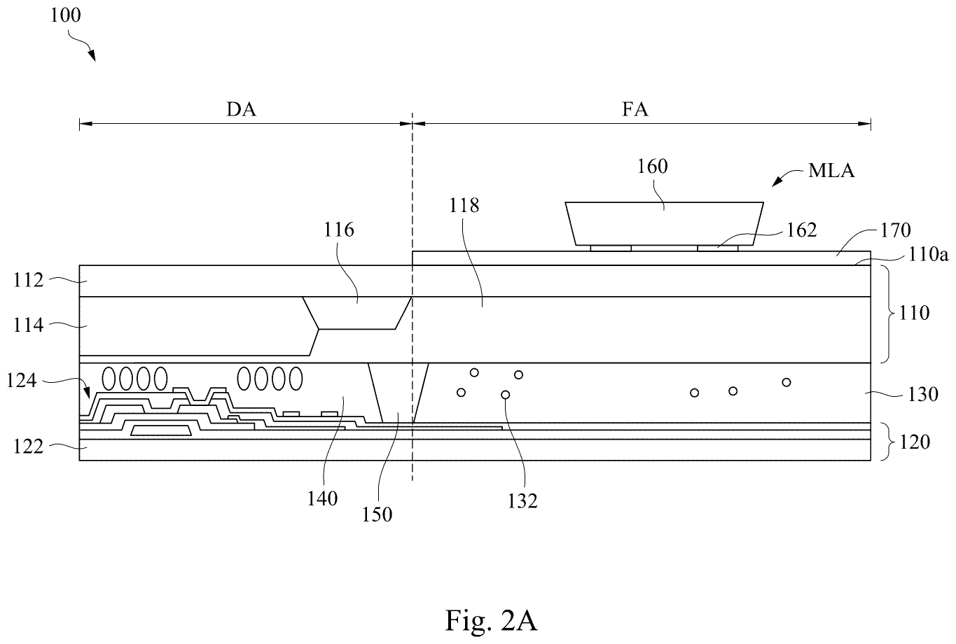

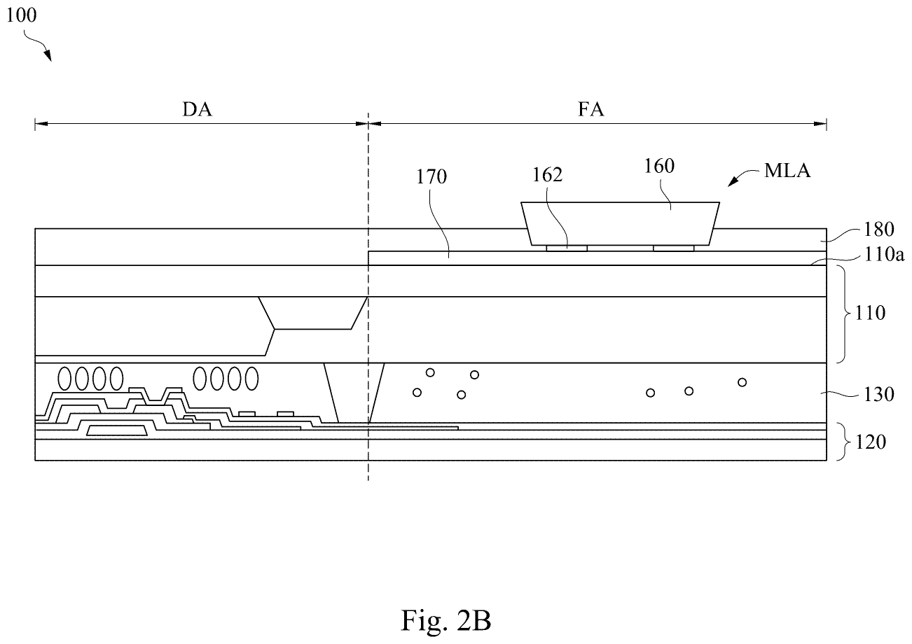

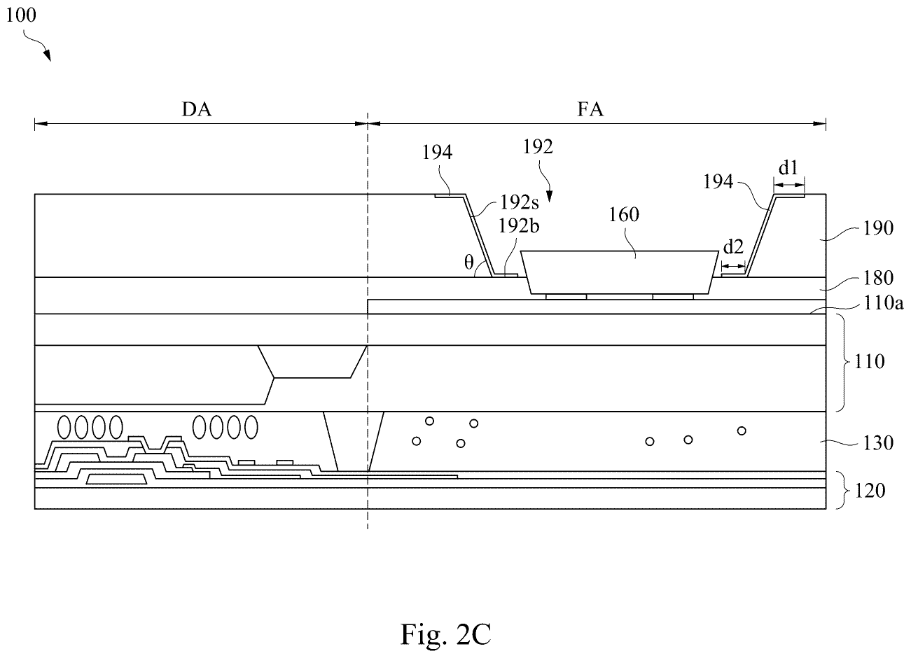

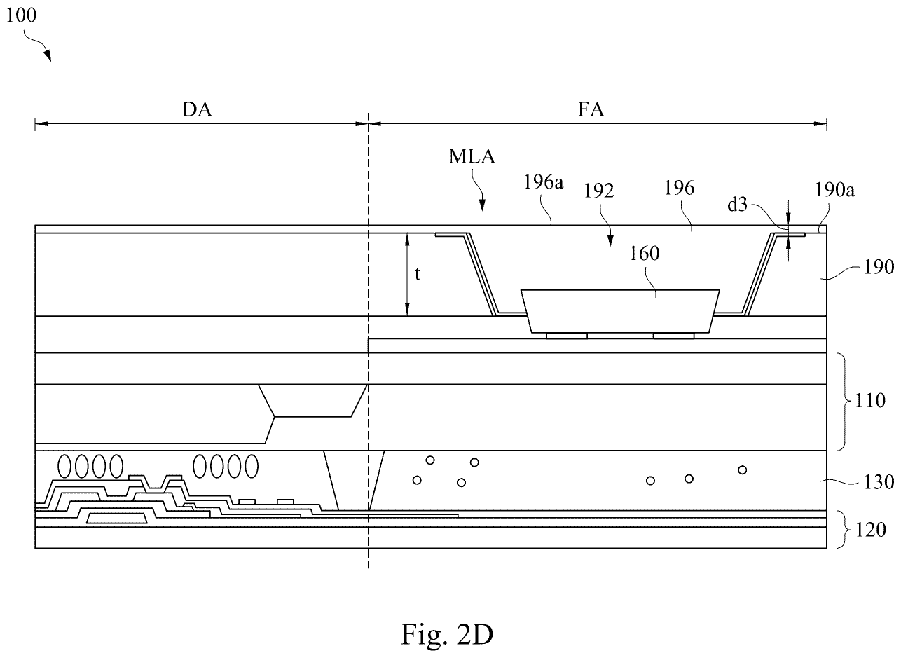

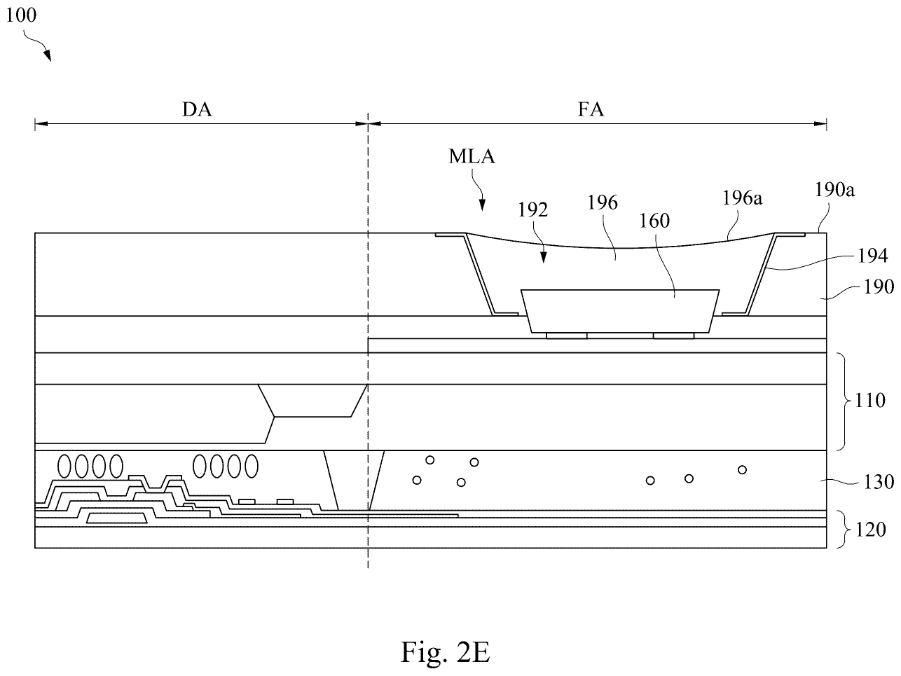

Reference is made to FIG. 2A to FIG. 2D, which are cross-sectional views of different manufacturing stages of the display panel according to some embodiments of the disclosure, in which the cross-section of FIG. 2A to FIG. 2D are taken along line A-A′ in FIG. 1. In FIG. 2A, the display panel 100 including the μLED array MLA is provided. The display panel 100 has the display area DA and the frame area FA that surrounds the display area DA. The display panel 100 includes a first substrate 110, a second substrate 120, and a sealant 130. The sealant 130 is configured to bond the first substrate 110 with the second substrate 120 at the frame area FA. The μLED array MLA is disposed at an outer surface 110a of the first substrate 110.

More particularly, in this embodiment, the first substrate 110 is a color filter substrate (hereafter color filter substrate 110), and the second substrate 120 is an array substrate (hereafter array substrate 120). The display panel 100 emits light from the color filter substrate 110, and the μLED array MLA is disposed at the outer surface 110a as the light emitting side of the color filter substrate 110.

The color filter substrate 110 includes a transparent substrate 112, a plurality of color filter films 114 disposed at the display area DA of the transparent substrate 112, and a light-shielding layer 116 disposed between the color filter films 114. The color filter films 114 are configured to filter different color wavebands. The light-shielding layer 116 for example can be black matric. The color filter substrate 110 further includes a color filter planarization layer 118, in which the color filter planarization layer 118 covers the frame area FA and the display area DA thereby providing a planar surface on the color filter films 114. The color filter planarization layer 118 for example can be high aspect ratio planarization layer. The array substrate 120 includes a glass substrate 122, a plurality of thin film transistors (TFTs) 124 on the substrate 122, and a driving circuit (not shown) connected to the TFTs 124.

The display panel 100 further includes a liquid crystal layer 140 disposed at the display area DA between the color filter substrate 110 and the array substrate 120. The TFTs 124 are configured to drive and tune the arrangement of the liquid crystal layer 140. The display panel 100 further includes a spacer 150. The spacer 150 connects the color filter planarization layer 118 on the color filter substrate 110 to the array substrate 120 to divide the sealant 130 and the liquid crystal layer 140 thereby preventing the sealant 130 from flowing to the liquid crystal layer 140 and the TFTs 124. Namely, the spacer 150 can be utilized to define the display area DA (e.g. the area where the liquid crystal layer 140 distributed) and the frame area FA (e.g. the area where the sealant 130 distributed). In some embodiments, the sealant 130 may further include scatter particles 132 therein.

The μLED array MLA is disposed at the outer surface 110a of the color filter substrate 110. The μLED array MLA includes a plurality of μLEDs 160 (only one is illustrated in the drawing), in which each of the μLEDs 160 is a sub-pixel. The μLEDs 160 are lateral light-emitting diodes, and the electrodes 162 thereof are located at the same side of the μLEDs 160. The electrodes 162 of the μLEDs 160 are connected to a pixel circuit layer 170 at the outer surface 110a of the color filter substrate 110.

Then as shown in FIG. 2B, an isolation layer 180 is coated on the outer surface 110a of the color filter substrate 110, to prevent short-circuit caused by unwanted contacts between the electrodes 162 of the μLEDs 160 and the pixel circuit layer 170. The material of the isolation layer 180 for example can be optical clear adhesive (OCA). The isolation layer 180 extends and covers the outer surface 110a of the color filter substrate 110. The isolation layer 180 also fills the gaps between the electrodes 162 of the μLEDs 160 and the pixel circuit layer 170.

The isolation layer 180 wraps bottom portions of the μLEDs 160. In some embodiments, the height of the isolation layer 180 is equal to or less than half of the height of the μLEDs 160. In some embodiments, the isolation layer 180 extends from the frame area FA into the display area DA. Alternatively, in some other embodiments, the portion of the isolation layer 180 at the display area DA is removed, and the portion of the isolation layer 180 at the frame area FA is remained and fills the gaps between the electrodes 162 of the μLEDs 160 and the pixel circuit layer 170.

Then, as shown in FIG. 2C, a planarization layer 190 is deposited on the outer surface 110a of the color filter substrate 110. The planarization layer 190 covers the isolation layer 180 and the μLEDs 160 thereon. The planarization layer 190 is a transparent dielectric layer such as high aspect ratio planarization layer. In some embodiments, the planarization layer 190 continuously extends from the frame area FA into the display area DA.

In FIG. 2C, portions of the planarization layer 190 are removed thereby defining a plurality of reflective cavities 192 (only one is illustrated in the drawing) in the planarization layer 190. For example, a mask etching process is performed to remove portions of the planarization layer 190 on the μLEDs 160 such that the μLEDs 160 are exposed by the reflective cavities 192. In some embodiments, the mask etching process stops at the isolation layer 180, thus a portion of the isolation layer 180 is remained at the bottom of the reflective cavities 192. In some embodiments, one μLED 160 is disposed in one reflective cavity 192.

In some embodiments, a cross-sectional shape of each of the reflective cavities 192 is a trapezoid which top is wider than bottom. An angle θ between the sidewall 192s and the bottom surface 192b of each of the reflective cavities 192 is in a range from 50 degrees to 60 degrees. The outer surface 110a of the color filter substrate 110 is substantially parallel to the surface of the planarization layer 190, so that it can be regarded that an angle between the sidewall 192s of each of the reflective cavities 192 and the outer surface 110a of the color filter substrate 110 is in a range from 50 degrees to 60 degrees.

Additionally, a reflective layer 194 is coated on the sidewall 192s of each of the reflective cavities 192. The material of the reflective layer 194 can be metal such as Al, Ag, Au, but not limited to.

In some embodiments, the reflective layer 194 not only covers the sidewall 192s of each of the reflective cavities 192, but also laterally extends from top of each of the reflective cavities 192 to the top surface of the planarization layer 190 with a distance d1. The distance d1 is preferable not greater than 5 μm, such that the light from the μLEDs 160 does not emitted from top of sidewall 192s of each of the reflective cavities 192, and the problem of light leakage can be prevented.

In some embodiments, the reflective layer 194 not only covers the sidewall 192s of each of the reflective cavities 192, but also laterally extends from sidewall 192s of each of the reflective cavities 192 to the top surface of the isolation layer 180 with a distance d2. The distance d2 is preferable not greater than 5 μm to prevent the reflective layer 194 contacting the μLEDs 160. Additionally, the isolation layer 180 is disposed between the planarization layer 190 and the circuit layer 170, such that the problem of short-circuit caused by the reflective layer 194 at the bottom of the reflective cavities 192 directly contacts the electrodes 162 of the μLEDs 160.

Then, as shown in FIG. 2D, a filling material 196 is filled in the reflective cavities 192. The filling material 196 can be optical clear adhesive or over molding material having high transparency. In some embodiments, the filling material 196 may overfill the reflective cavities 192, such that the top surface 196a of the filling material 196 is higher than the top surface 190a of the planarization layer 190. The distance d3 between the top surface 196a of the filling material 196 and the top surface 190a of the planarization layer 190 is not greater than ⅓ of the thickness t of the planarization layer 190. If the distance d3 is greater than ⅓ of the thickness t of the planarization layer 190, the light emitted from the μLEDs 160 may be total reflected in the portion of the filling material 196 on the top surface 190a of the planarization layer 190, thereby reducing optical performance of the μLEDs 160 of the display panel 100.

Optionally, in some other embodiments, the filling material 196 does not completely fill the reflective cavities 192, such that the top surface 196a of the filling material 196 is recessed from the top surface 190a of the planarization layer 190, as shown in FIG. 2E.

Accordingly, the display panel 100 provided by the embodiments of the disclosure includes the μLED array MLA disposed at the frame area FA and on the outer surface 110a of the color filter substrate 110. The display panel 100 includes the planarization layer 190 disposed on the outer surface 110a of the color filter substrate 110, and plural reflective cavities 192 are defined in the planarization layer 190. The μLEDs 160 of the μLED array MLA are disposed in the reflective cavities 192, respectively. The reflective layer 194 is disposed on the sidewall 192s of each of the reflective cavities 192.

The light emitted of the μLEDs 160 towards the sidewall 192s of each of the reflective cavities 192 is reflected by the reflective layer 194, and the light path of the μLEDs 160 is tuned by the reflective cavities 192 with the reflective layer 194. Therefore, the light path of light emitted of the μLEDs 160 becomes more collimated thereby solving the problem of view angle discontinuous caused by the different light field shapes between LCD and LED.

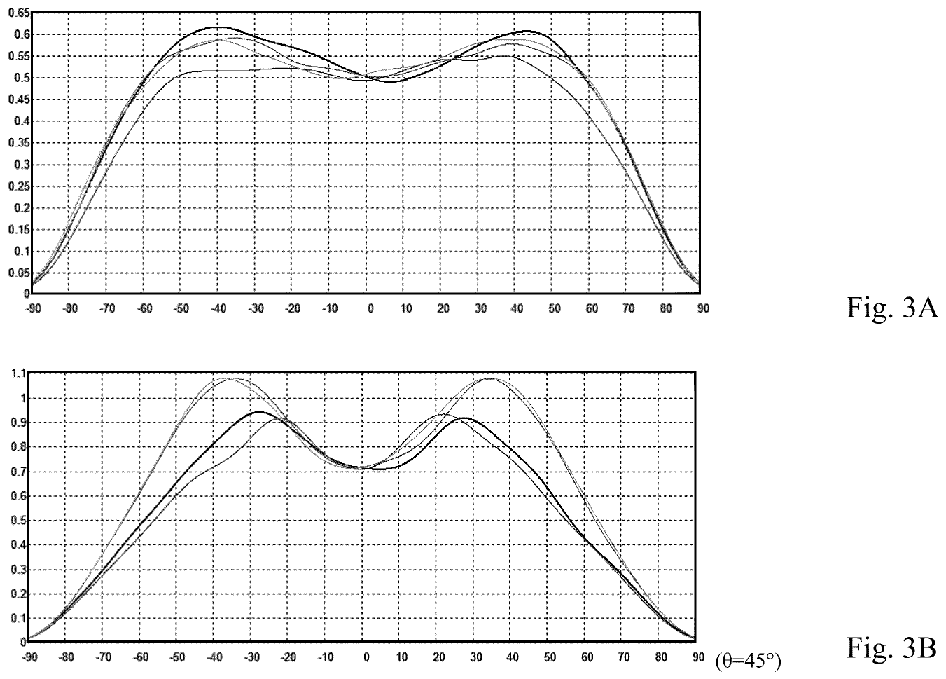

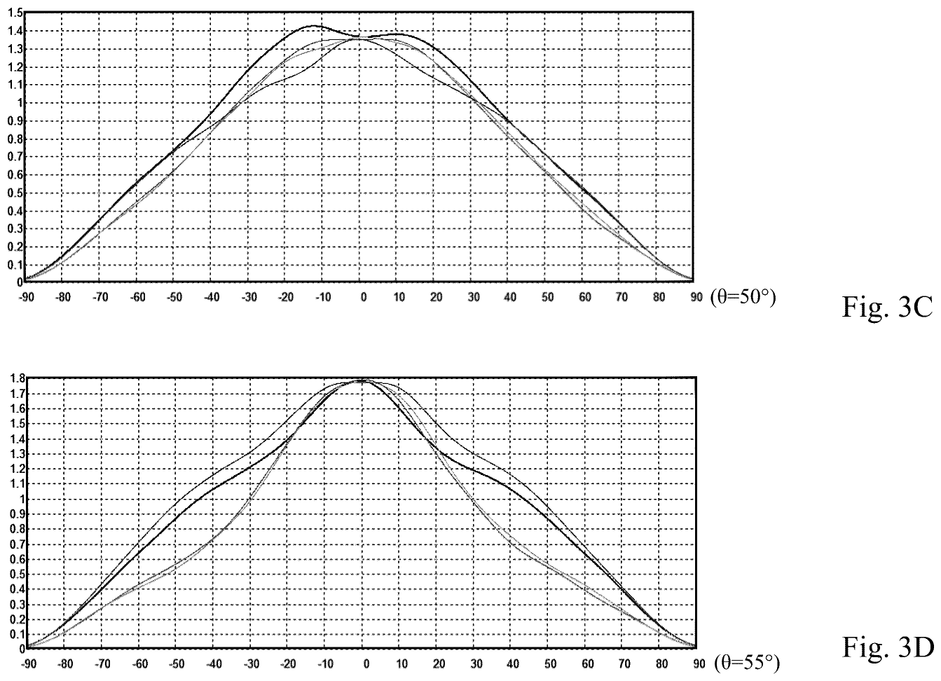

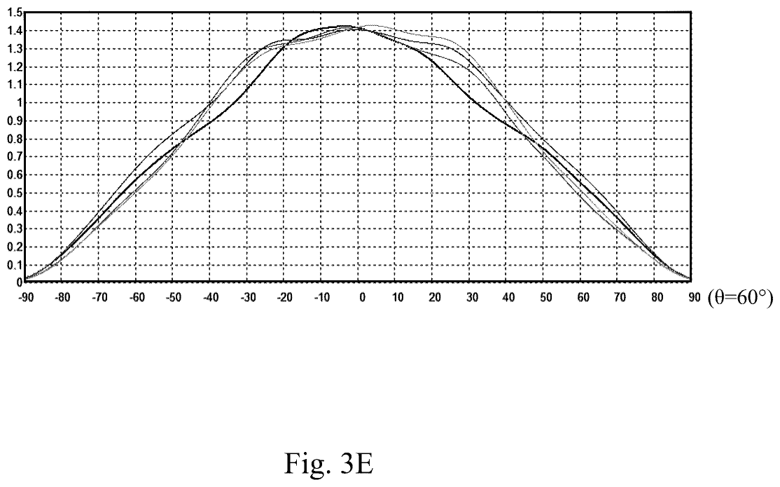

Reference is made to FIG. 3A to FIG. 3E, in which FIG. 3A is a front view angle diagram of a μLED, FIG. 3B to FIG. 3E are simulation front view angle diagrams of a μLED disposed in the reflective cavity as shown in the display panel of FIG. 2D with different angles θ. As shown in FIG. 3A, the light spreading angle of the μLED without the reflective cavity is wider, and the maximum light intensity is shifted from the center of the μLED.

FIG. 3B to FIG. 3E are simulation front view angle diagrams of the μLED disposed in the reflective cavity, with the angles θof 45 degrees, 50 degrees, 55 degrees, and 60 degrees between the sidewall of the reflective cavity and the outer surface of the color filter substrate, respectively. According to FIG. 3B, when the angle θ between the sidewall of the reflective cavity and the outer surface of the color filter substrate is 45 degrees, the light spreading angle of the μLED is more converged than that in FIG. 3A, but the maximum light intensity is still shifted from the center of the μLED.

According to FIG. 3C to FIG. 3E, when the angle θ between the sidewall of the reflective cavity and the outer surface of the color filter substrate is 50degrees, 55 degrees, or 60 degrees, the light spreading angle of the μLED becomes converged, and the maximum light intensity is on the center of the μLED. Therefore, it is benefit to converge the light spreading angle of the μLED when the angle θ between the sidewall of the reflective cavity and the outer surface of the color filter substrate is in a range from 50 degrees to 60 degrees, thereby allowing the light field shape of LED at the frame area similar to the light field shape of LCD at the display area, to solve the problem of view angle discontinuous caused by the different light field shapes between LCD and LED.

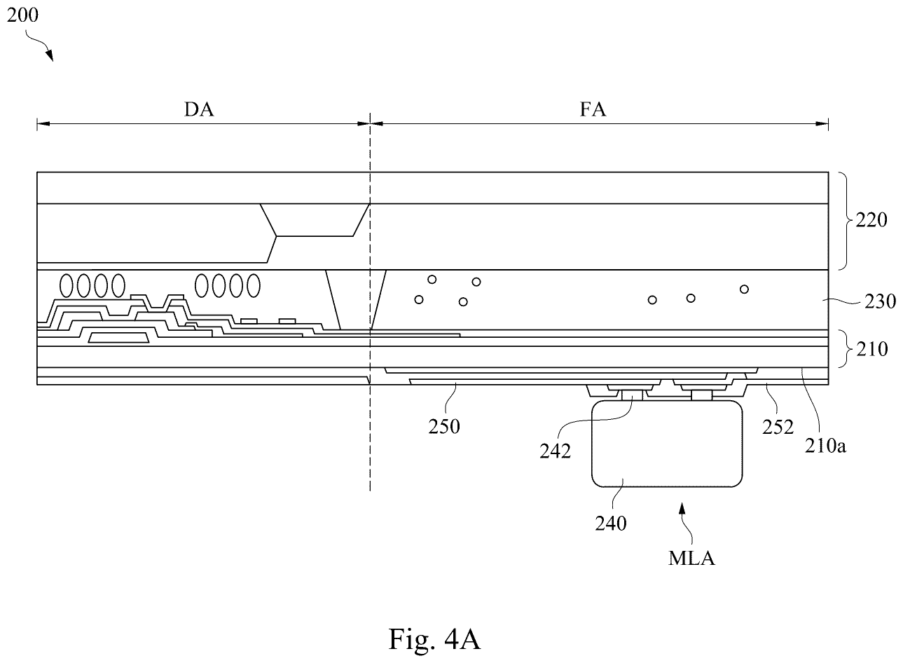

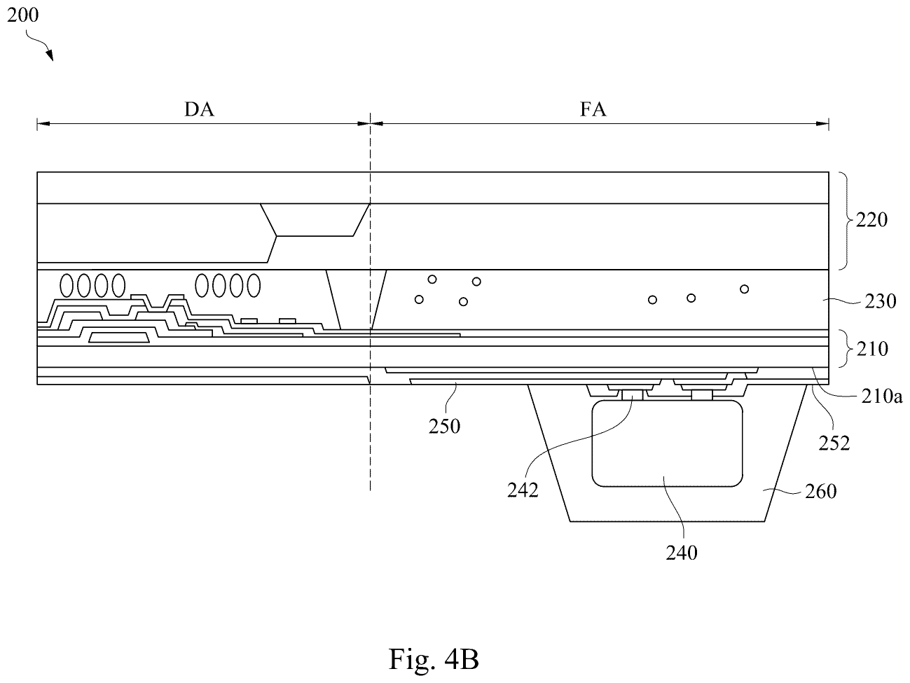

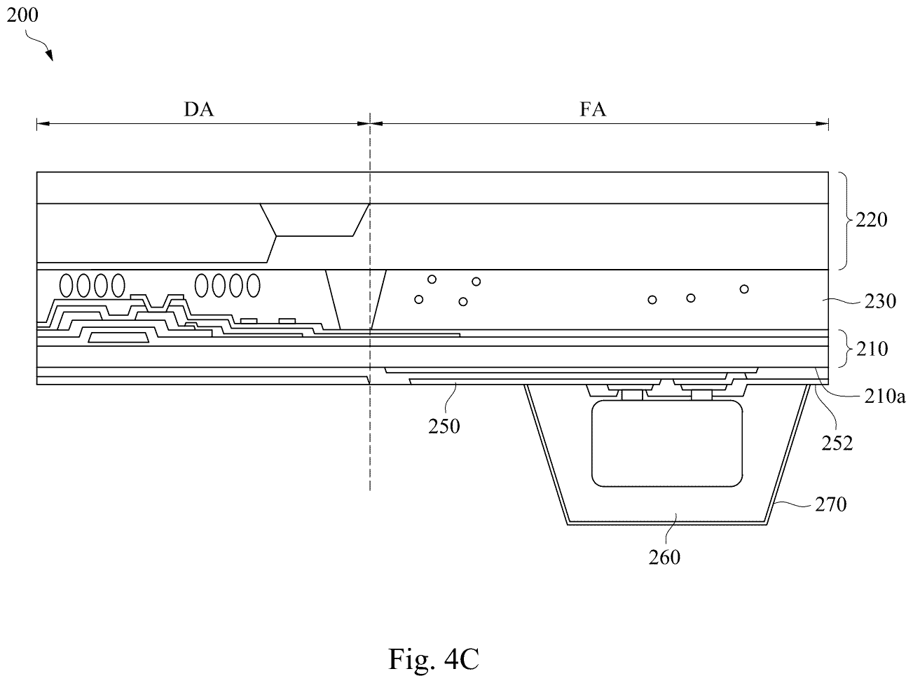

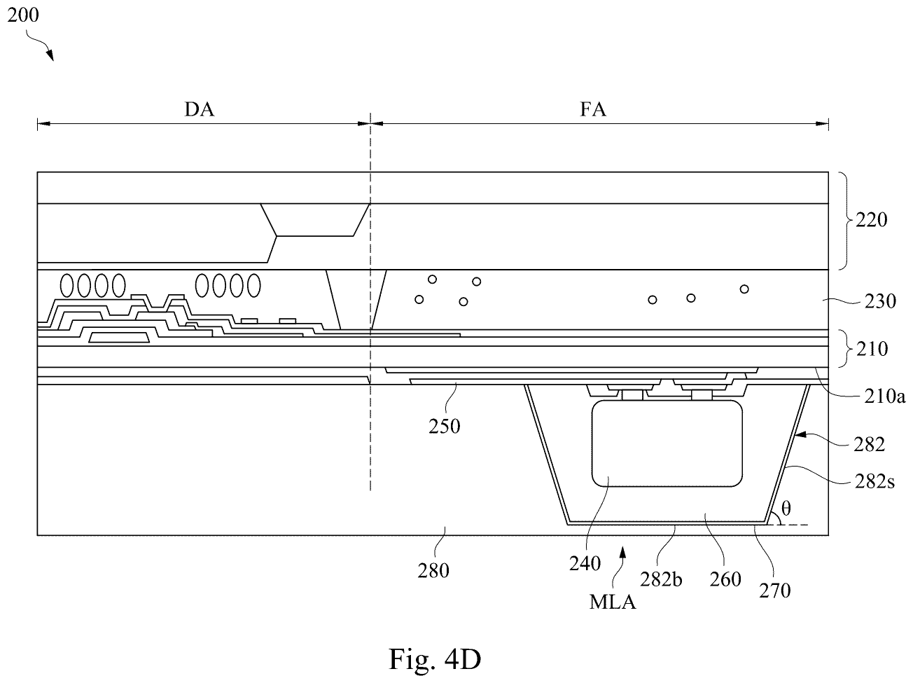

Reference is made to FIG. 4A to FIG. 4D, which are cross-sectional views of different manufacturing stages of the display panel according to some embodiments of the disclosure, in which the cross-section of FIG. 4A to FIG. 4D are taken along line A-A′ in FIG. 1. In FIG. 4A, the display panel 200 including the μLED array MLA is provided. The display panel 200 has the display area DA and the frame area FA that surrounds the display area DA. The display panel 200 includes the first substrate 210, the second substrate 220, and the sealant 230. The sealant 230 is configured to bond the first substrate 210 with the second substrate 220 at the frame area FA. The μLED array MLA is disposed at an outer surface 210a of the first substrate 210.

More particularly, in this embodiment, the first substrate 210 is an array substrate (hereafter array substrate 210), and the second substrate 220 is a color filter substrate (hereafter color filter substrate 220). The display panel 200 emits light from the color filter substrate 220, and the μLED array MLA is disposed at the outer surface 210a of the array substrate 210, which is the surface opposite to the light emitting side. Also, the light emitting direction of the μLED array MLA is opposite to the light emitting side of the display panel 200.

In some embodiments, the pixel circuit layer 250 and the passivation layer 252 are disposed on the outer surface 210a of the array substrate 210. The pixel circuit layer 250 is buried in the passivation layer 252, and portions of the pixel circuit layer 250 are exposed from the passivation layer 252, so that the electrodes 242 of the μLEDs 240 (only one is illustrated in the drawing) can be coupled to the pixel circuit layer 250. The passivation layer 252 not only protects the pixel circuit layer 250, but also provides a planar surface for the following processes.

As shown in FIG. 4B, an insulating material is deposited on the outer surface 210a of the array substrate 210, and the insulating material is patterned. A plurality of insulating protrusions 260 (only one is illustrated in the drawing) that disposed on the frame area FA and respectively wrapping the μLEDs 240 are provided. In some embodiments, each of the insulating protrusions 260 fills the gap between the electrodes 242 of the corresponding μLEDs 240 and the pixel circuit layer 250. The insulating protrusions 260 may cover the pixel circuit layer 250 on the array substrate 210 and the passivation layer 252.

Each of the insulating protrusions 260 has a cross-sectional shape having top width greater than bottom width. Namely, the width of each of the insulating protrusions 260 closer to the array substrate 210 is wider than the width of each of the insulating protrusions 260 farther to the array substrate 210. The cross-sectional shape of each of the insulating protrusions 260 for example can be a trapezoid with a wider top and a narrower bottom.

As shown in FIG. 4C, the reflective layer 270 is coated on each of the insulating protrusions 260. The material of the reflective layer 270 can be metal such as Al, Ag, Au, but not limited to. In some embodiments, the reflective layer 270 is coated on the surface of each of the insulating protrusions 260 and is in contact with the pixel circuit layer 250 and the passivation layer 252.

As shown in FIG. 4D, the planarization layer 280 is disposed on the outer surface 210a of the array substrate 210 and entirely covers the insulating protrusions 260 and the reflective layer 270 thereon. In some embodiments, the material of the planarization layer 280 can be optical clear adhesive, and the planarization layer 280 continuously extends from the frame area FA to the display area DA.

Plural reflective cavities 282 (only one is illustrated in the drawing) are defined in the planarization layer 280. The shape of the reflective cavities 282 is conformal to the shape of insulating protrusions 260, and the reflective cavities 282 are filled in the reflective cavities 282, respectively. The refractive index of the insulating protrusions 260 is about 1.51. The reflective layer 270 is disposed on the sidewall 282s and the bottom surface 282b of each of the reflective cavities 282, and the light emitted from the μLEDs 240 is reflected back towards the light emitting side at the color filter substrate 220.

An angle θ between the sidewall 282s and the bottom surface 282b of each of the reflective cavities 282 is in a range from 25 degrees to 45 degrees or in a range from 60 degrees to 80 degrees. The outer surface 210a of the array substrate 210 is substantially parallel to the surface of the planarization layer 280, so that it can be regarded that an angle between the sidewall 282s of each of the reflective cavities 282 and the outer surface 210a of the array substrate 210 is in a range from 25 degrees to 45 degrees or in a range from 60 degrees to 80 degrees. The light path of the μLEDs 240 can be tuned by the angle θ of the reflective cavities 282, so that the light path of light emitted of the μLEDs 240 becomes more collimated thereby solving the problem of view angle discontinuous caused by the different light field shapes between LCD and LED.

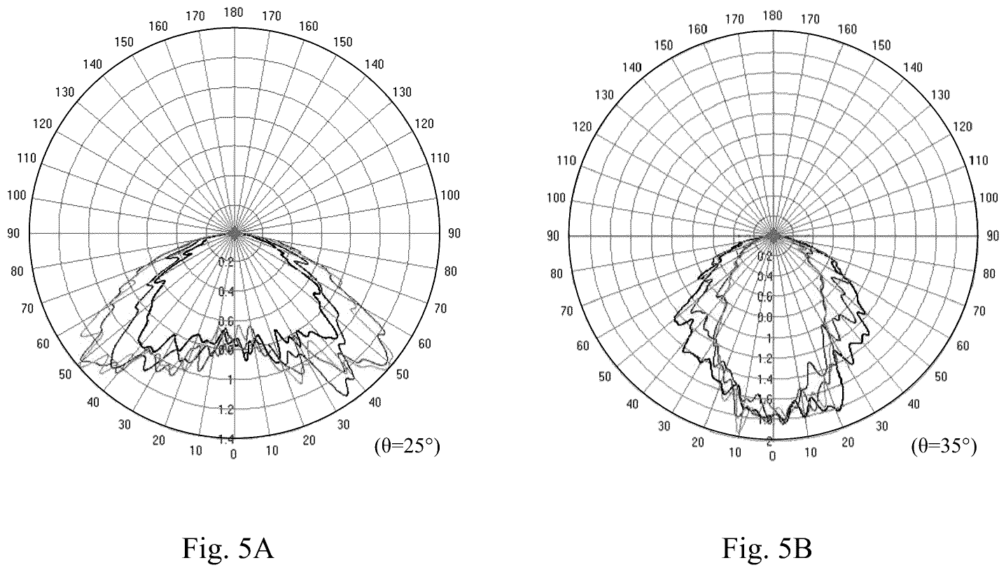

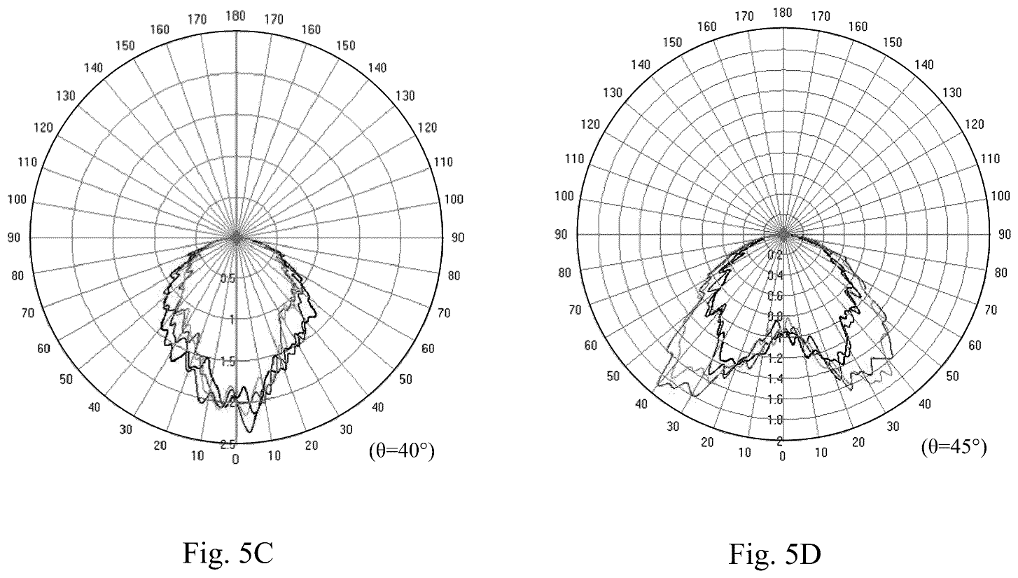

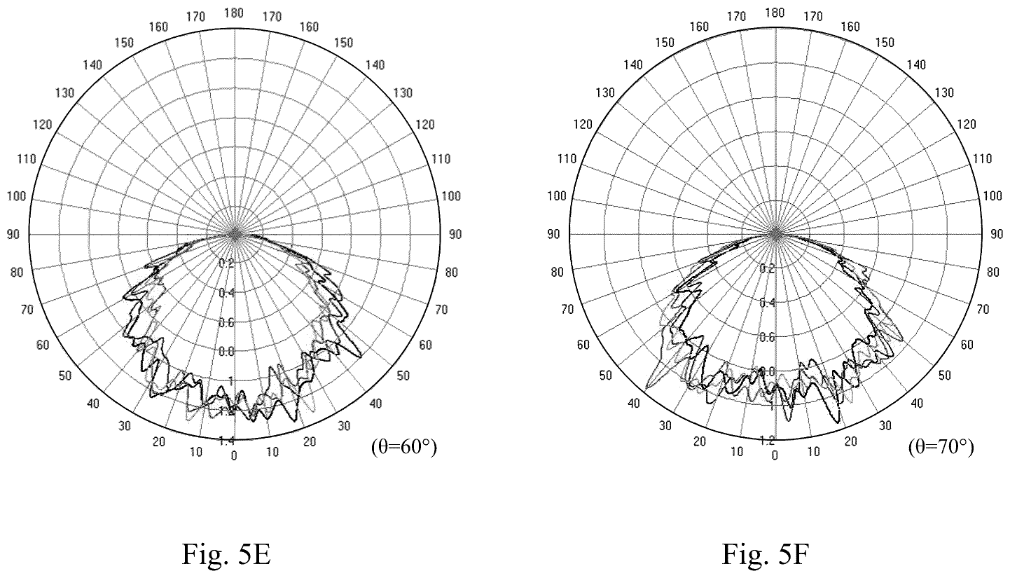

Reference is made to FIG. 5A to FIG. 5F, which are simulation light fields of a μLED disposed in the reflective cavity as shown in the display panel of FIG. 4D with different angles θ. FIG. 5A to FIG. 5F are simulation light fields of the μLED disposed in the reflective cavity, with the angles θ of 25 degrees, 35 degrees, 40 degrees, 45 degrees, 60 degrees, and 70 degrees between the sidewall of the reflective cavity and the outer surface of the array substrate, respectively. According to FIG. 5A to FIG. 5F, when the angle θ between the sidewall of the reflective cavity and the outer surface of the array substrate is 35 degrees or 70 degrees, the light spreading angle of the μLED is more converged without split light intensities. Therefore, it is assumed that is benefit to converge the light spreading angle of the μLED when the angle θ between the sidewall of the reflective cavity and the outer surface of the array substrate is in a range from 25 degrees to 45 degrees or in a range from 60 degrees to 80 degrees, thereby allowing the light field shape of LED at the frame area similar to the light field shape of LCD at the display area.

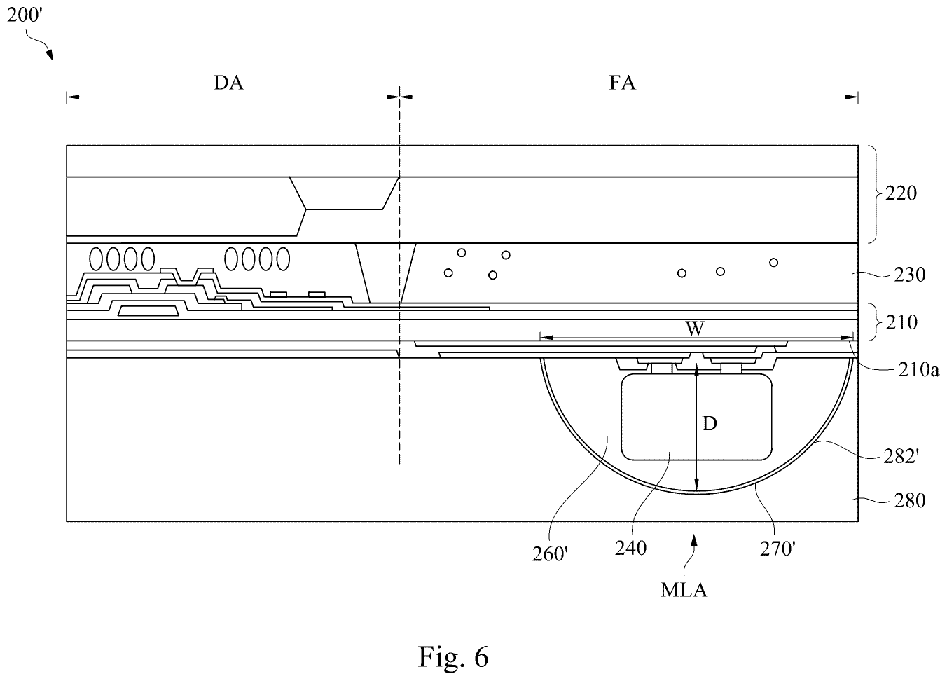

Reference is made to FIG. 6, which is a cross-sectional view of the display panel according to some other embodiments of the disclosure. One of the main differences between the display panel 200′ and the display panel 200 is that the cross-sectional shape of each of the insulating protrusions 260′ formed by patterning the insulating material is a dome. Accordingly, the cross-sectional shape of each of the reflective cavities 282′ and the reflective layer 270′ is a dome.

Each of the reflective cavities 282′ is a dome structure. The refractive index of the insulating protrusions 260′ in the reflective cavities 282′ is about 1.51. Each of the reflective cavities 282′ has a width W and a depth D, in which the width W is measured at the widest region of the reflective cavity 282′, and the depth D is measured at the deepest region of the reflective cavity 282′. The ratio of the depth D to the width W (D/W) is in a range from 0.2 to 0.3. The light path of the μLEDs 240 can be tuned by the D/W ratio of the reflective cavities 282′, so that the light path of light emitted of the μLEDs 240 becomes more collimated thereby solving the problem of view angle discontinuous caused by the different light field shapes between LCD and LED.

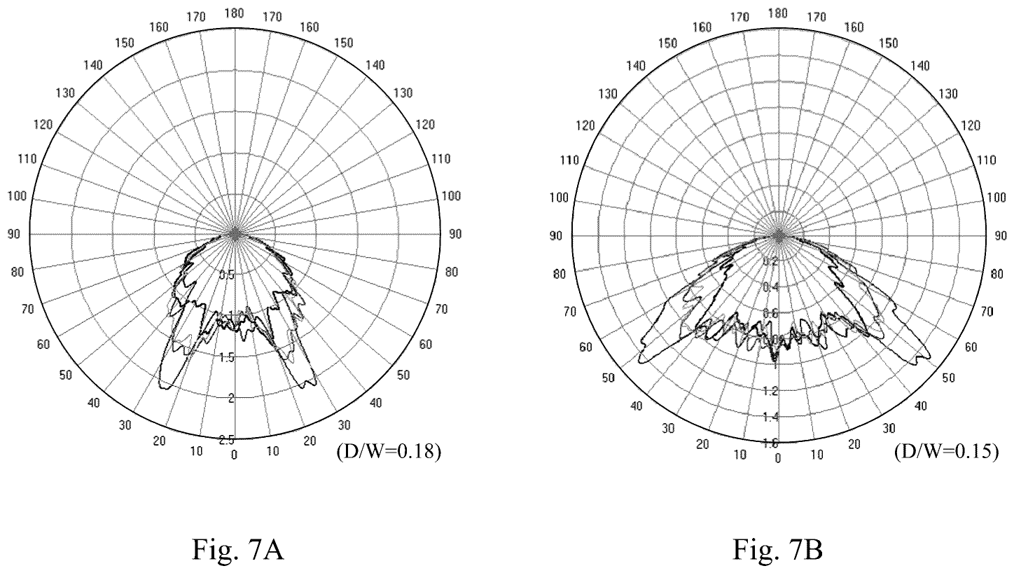

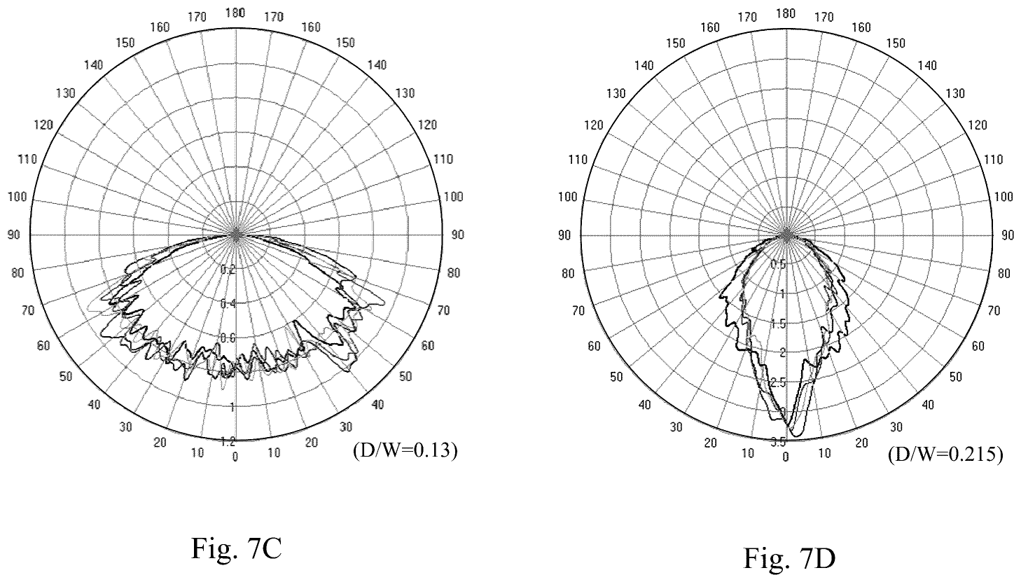

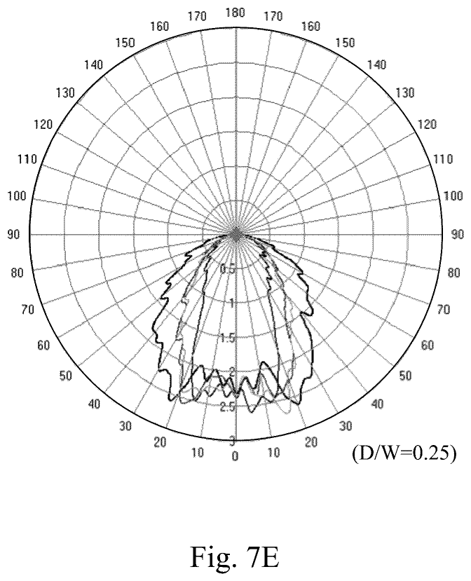

Reference is made to FIG. 7A to FIG. 7E, which are simulation light fields of a μLED disposed in the reflective cavity as shown in the display panel of FIG. 6 with different D/W ratios. According to FIG. 7A to FIG. 7E, when the D/W ratio of the reflective cavity is 0.215 or 0.25, the light spreading angle of the μLED is more converged without split light intensities. Therefore, it is assumed that is benefit to tune the light path and converge the light spreading angle of the μLED when the D/W ratio of the reflective cavity is in a range from 0.2 to 0.3, thereby allowing the light field shape of LED at the frame area similar to the light field shape of LCD at the display area.

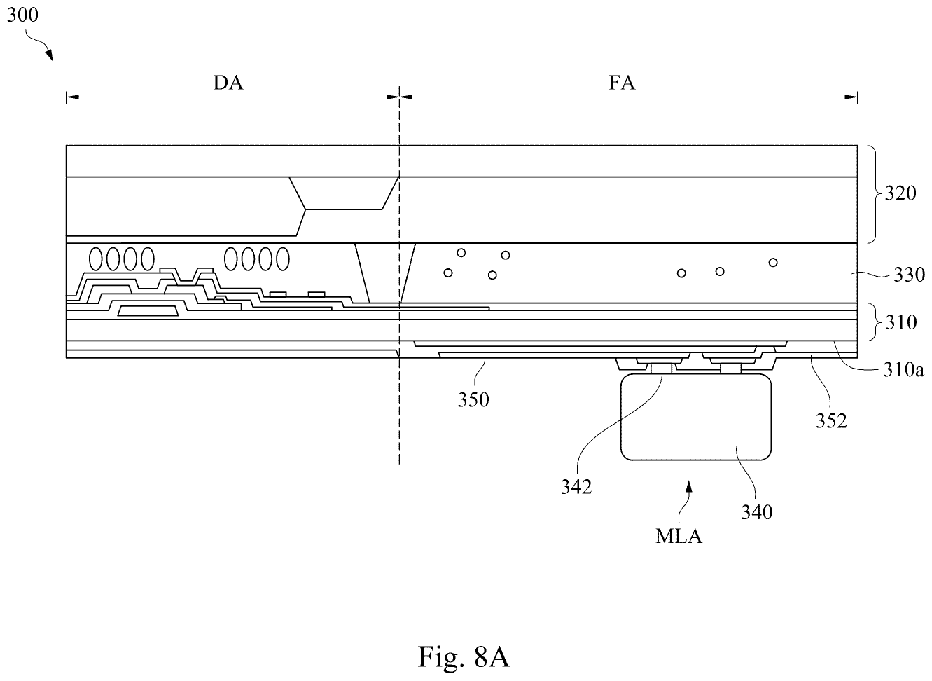

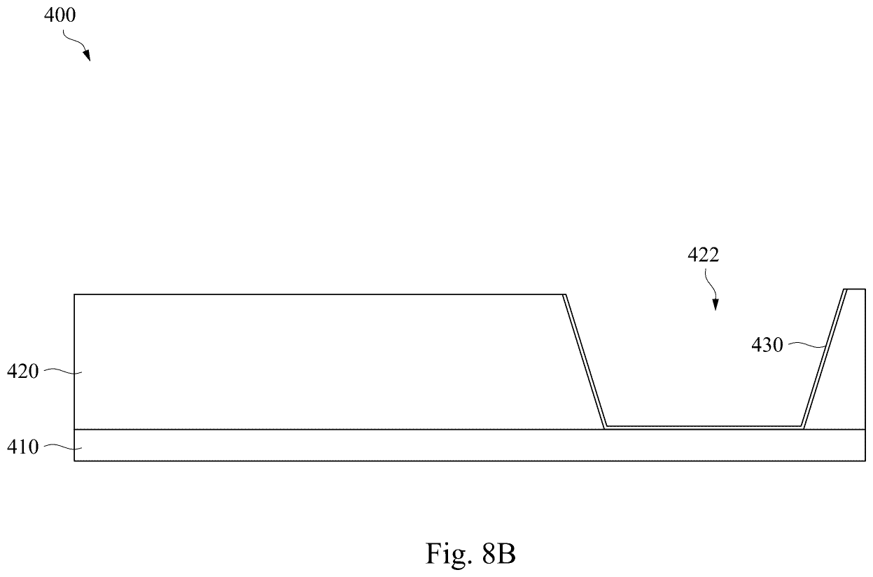

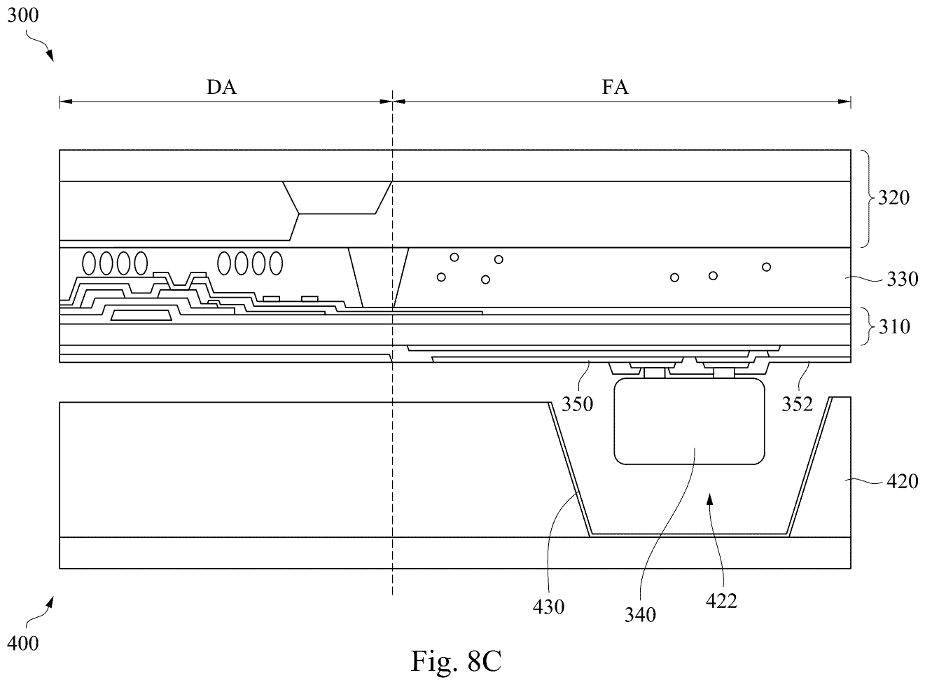

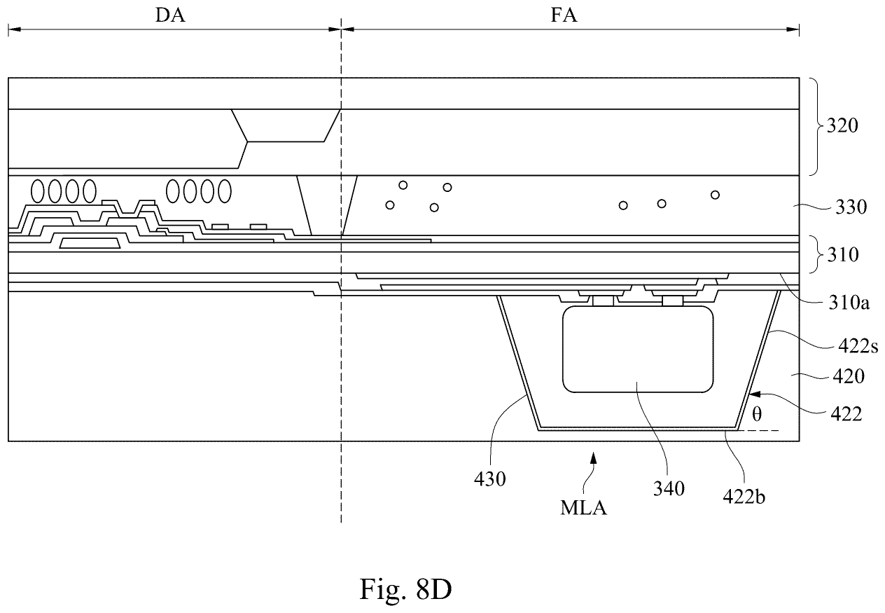

Reference is made to FIG. 8A to FIG. 8D, which are cross-sectional views of different manufacturing stages of the display panel according to some embodiments of the disclosure, in which the cross-section of FIG. 8A to FIG. 8D are taken along line A-A′ in FIG. 1. In FIG. 8A, the display panel 300 including the μLED array MLA is provided. The display panel 300 has the display area DA and the frame area FA that surrounds the display area DA. The display panel 300 includes the first substrate 310, the second substrate 320, and the sealant 330. The sealant 330 is configured to bond the first substrate 310 with the second substrate 320 at the frame area FA. The μLED array MLA is disposed at an outer surface 310a of the first substrate 310.

More particularly, in this embodiment, the first substrate 310 is an array substrate (hereafter array substrate 310), and the second substrate 320 is a color filter substrate (hereafter color filter substrate 320). The display panel 300 emits light from the color filter substrate 320, and the μLED array MLA is disposed at the outer surface 310a of the array substrate 310, which is the surface opposite to the light emitting side. Also, the light emitting direction of the μLED array MLA is opposite to the light emitting side of the display panel 300.

In some embodiments, the pixel circuit layer 350 and the passivation layer 352 are disposed on the outer surface 310a of the array substrate 310. The pixel circuit layer 350 is buried in the passivation layer 352, and portions of the pixel circuit layer 350 are exposed from the passivation layer 352, so that the electrodes 342 of the μLEDs 340 (only one is illustrated in the drawing) can be coupled to the pixel circuit layer 350. The passivation layer 352 not only protects the pixel circuit layer 350, but also provides a planar surface for the following processes.

As shown in FIG. 8B, a reflective cavity substrate 400 is provided. The reflective cavity substrate 400 includes a carrier substrate 410 and a planarization layer 420 on the carrier substrate 410. The planarization layer 420 is patterned to define plural reflective cavities 422 in the planarization layer 420. The shape of each of the reflective cavities 422 has a wider top and a narrower bottom. Each of the reflective cavities 422 for example can be a trapezoid structure or a dome structure. In some embodiments, the material of the planarization layer 420 can be optical clear adhesive.

As shown in FIG. 8B, the reflective layer 430 is formed on the inner surface each of the reflective cavities 422. The material of the reflective layer 430 can be metal such as Al, Ag, Au, but not limited to. In some embodiments, forming the reflective layer 430 on the inner surface each of the reflective cavities 422 includes depositing or coating a metal layer on the planarization layer 420, and removing portions of the metal other than in the reflective cavities 422.

Then, as shown in FIG. 8C, the display panel 300 as shown in FIG. 8A is assembled with the reflective cavity substrate 400 as shown in FIG. 8B, including using an adhesion to adhere the planarization layer 420 on the array substrate 310. The reflective layer 430 is formed only on the inner surface each of the reflective cavities 422, thus the problem of short-circuit due to unwanted contact between the reflective layer 430 and the pixel circuit layer 350 can be prevented.

In some embodiments, optionally, a filling material can be filled in the reflective cavities 422 before the display panel 300 is assembled with the reflective cavity substrate 400. Alternatively, as shown in this embodiment, air is filled between the reflective cavities 422 and the display panel 300. Namely, air media is in each of the reflective cavities 422.

As shown in FIG. 8D, the carrier substrate 410 is detached from the planarization layer 420. As a result, the display panel 300 including the reflective cavities 422 in the planarization layer 420 to tune the light path of the μLEDs 340 to be more collimated is provided.

In the embodiments of using air as media in the reflective cavities 422, the angle θ between the sidewall 422s and the bottom surface 422b of each of the reflective cavities 422 is in a range from 25 degrees to 45 degrees. The outer surface 310a of the array substrate 310 is substantially parallel to the surface of the planarization layer 420, so that it can be regarded that an angle between the sidewall 422s of each of the reflective cavities 422 and the outer surface 310a of the array substrate 310 is in a range from 25 degrees to 45 degrees.

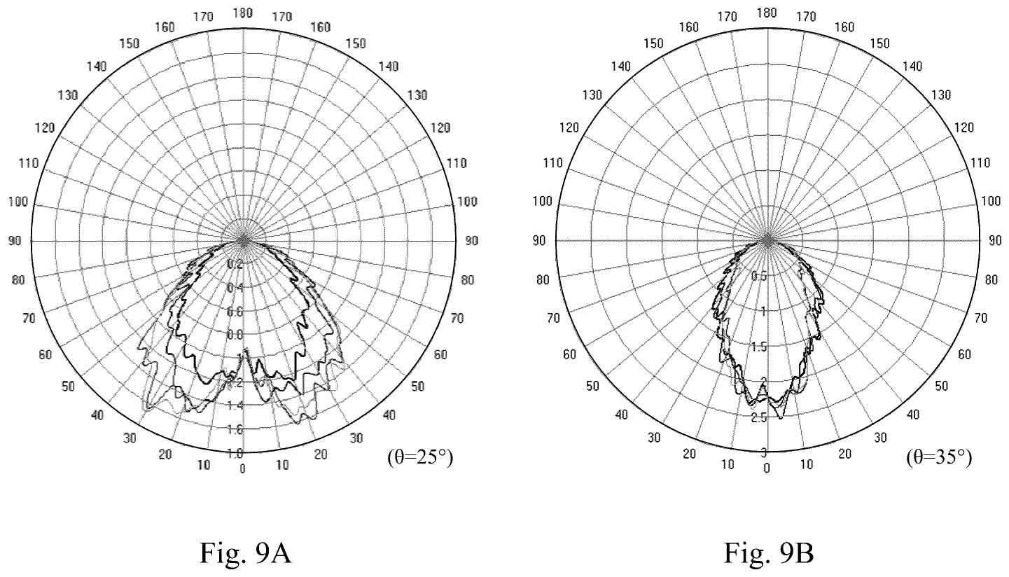

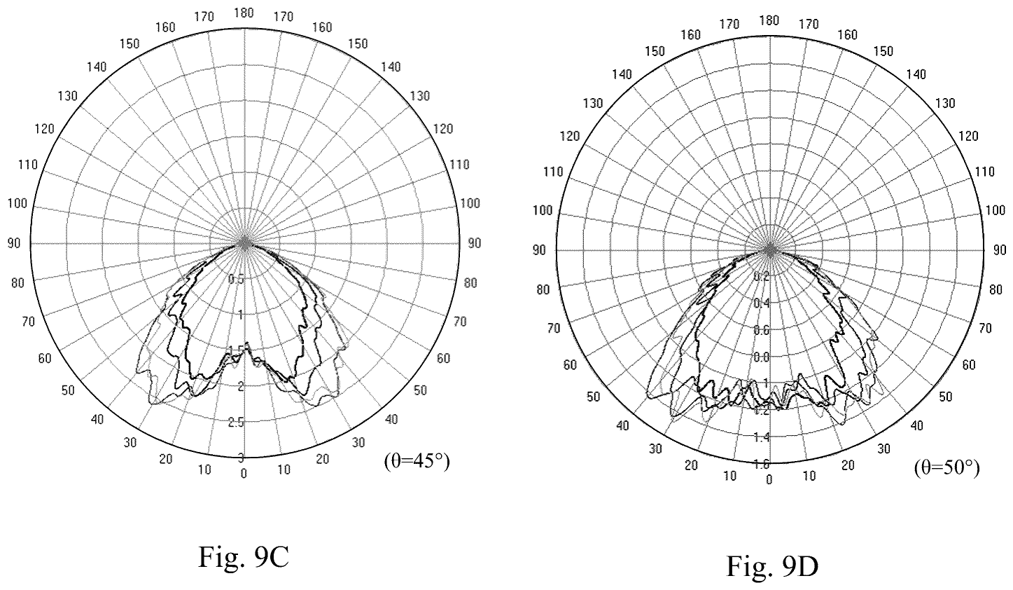

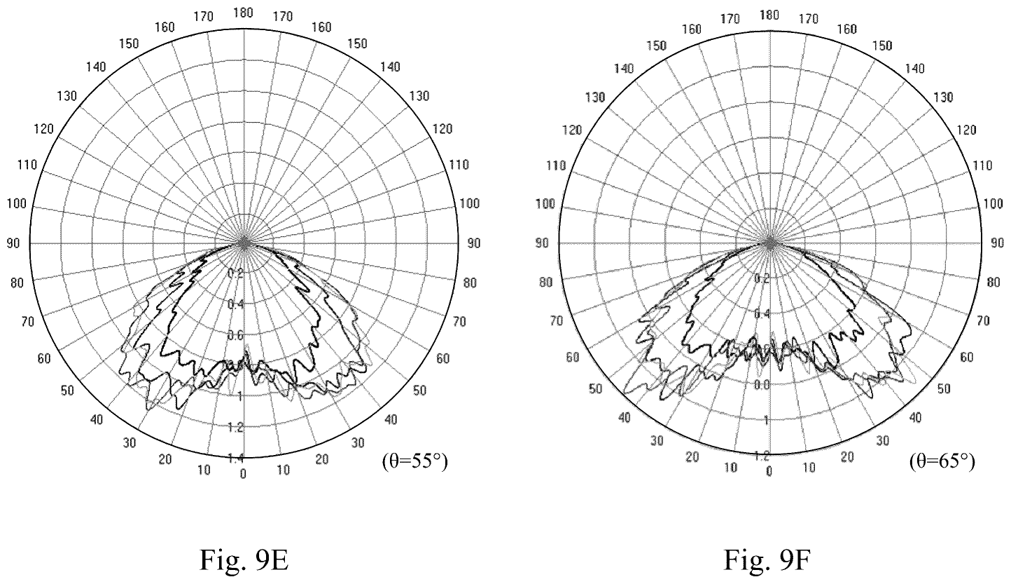

Reference is made to FIG. 9A to FIG. 9F, which are simulation light fields of a μLED disposed in the reflective cavity as shown in the display panel of FIG. 8D with different angles θ. FIG. 9A to FIG. 9F are simulation light fields of the μLED disposed in the reflective cavity, with the angles θ of 25 degrees, 35 degrees, 45degrees, 50 degrees, 55 degrees, and 65 degrees between the sidewall of the reflective cavity and the outer surface of the array substrate, respectively. According to FIG. 9A to FIG. 9F, when the angle θ between the sidewall of the reflective cavity and the outer surface of the array substrate is 35 degrees, the light spreading angle of the μLED is more converged without split light intensities.

Therefore, it is assumed that is benefit to converge the light spreading angle of the μLED when the angle θ between the sidewall of the reflective cavity and the outer surface of the array substrate is in a range from 25 degrees to 45 degrees, thereby allowing the light field shape of LED at the frame area similar to the light field shape of LCD at the display area, to solve the problem of view angle discontinuous caused by the different light field shapes between LCD and LED.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A display panel comprising:
a first substrate;
a second substrate;
a sealant configured to mount the first substrate and the second substrate at a frame area;
a display array disposed at a display area of the first substrate and the second substrate, wherein the display area is surrounded by the frame area;
a planarization layer disposed on an outer surface of the first substrate and comprising a plurality of reflective cavities; and
a micro-LED array disposed at the frame area and comprising a plurality of micro-LEDs, wherein the micro-LEDs are disposed in the reflective cavities.

2. The display panel of claim 1, wherein a surface of each of the reflective cavities is disposed with a reflective layer.

3. The display panel of claim 1, wherein the first substrate is a color filter substrate, and the planarization layer is disposed on the outer surface of the color filter substrate.

4. The display panel of claim 3, wherein each of the reflective cavities is a trapezoid structure, each of the reflective cavities is filled with a filling material, and an angle between a sidewall of each of the reflective cavities and the outer surface of the color filter substrate is in a range from 50 degrees to 60 degrees.

5. The display panel of claim 4, wherein the filling material is recessed form a top surface of the planarization layer.

6. The display panel of claim 4, wherein a top surface of the filling material is above a top surface of the planarization layer, and a distance between the top surface of the filling material and the top surface of the planarization layer is equal to or less than ⅓ of a thickness of the planarization layer.

7. The display panel of claim 3, further comprising an isolation layer disposed between the color filter substrate and the planarization layer.

8. The display panel of claim 3, wherein a surface of each of the reflective cavities is disposed with a reflective layer that laterally extended from each of the reflective cavities to a top surface of the planarization layer by a distance, and the distance is equal to or less than 5 μm.

9. The display panel of claim 1, wherein the first substrate is an array substrate, and the planarization layer is disposed on the outer surface of the array substrate.

10. The display panel of claim 9, wherein each of the reflective cavities is a trapezoid structure, each of the reflective cavities is filled with an insulating protrusion, and an angle between a sidewall of each of the reflective cavities and the outer surface of the array substrate is in a range from 25 degrees to 45 degrees or 60 degrees to 80 degrees.

11. The display panel of claim 9, wherein each of the reflective cavities is a trapezoid structure, each of the reflective cavities is filled with an air media, and an angle between a sidewall of each of the reflective cavities and the outer surface of the array substrate is in a range from 25 degrees to 45 degrees.

12. The display panel of claim 9, wherein each of the reflective cavities is a dome structure, each of the reflective cavities is filled with an insulating protrusion, and a ratio of a depth to a width of each of the reflective cavities is in a range from 0.2 to 0.3.

13. The display panel of claim 1, wherein the sealant comprises a plurality of scatter particles.

14. The display panel of claim 1, wherein the planarization layer continuously extends from the frame area to the display area.

15. The display panel of claim 1, wherein the micro-LEDs are disposed in the reflective cavities, respectively.

16. A tiled display comprising:
a plurality of display panel, each of the display panel comprising:
a first substrate;
a second substrate;
a sealant configured to mount the first substrate and the second substrate at a frame area;
a display array disposed at a display area of the first substrate and the second substrate, wherein the display area is surrounded by the frame area;
a planarization layer disposed on an outer surface of the first substrate and comprising a plurality of reflective cavities; and
a micro-LED array disposed at the frame area and comprising a plurality of micro-LEDs, wherein the micro-LEDs are disposed in the reflective cavities, wherein the display panels are tiled such that the micro-LED arrays of the display panels are between the display arrays of the display panels.

17. The tiled display of claim 16, wherein a surface of each of the reflective cavities is disposed with a reflective layer.

18. The tiled display of claim 16, wherein the micro-LEDs are disposed in the reflective cavities, respectively.

19. The tiled display of claim 16, wherein the first substrate is a color filter substrate, and the planarization layer is disposed on the outer surface of the color filter substrate.

20. The tiled display of claim 16, wherein the first substrate is an array substrate, and the planarization layer is disposed on the outer surface of the array substrate.
